(19) United States
(12) Patent Application Publication
(10) Pub. No.: US 2008/0086960 A1
(43) Pub. Date: Apr. 17, 2008

(54) Blast mitigation system

(76) Inventor: Mordechay Emek, Kfar Shmariahu (IL)

Correspondence Address: KRAMER & AMADO, P.C., 1725 DUKE STREET, SUITE 240, ALEXANDRIA, VA, 22314, US

(21) Appl. No.: 11/802,274

(22) Filed: May 22, 2007

(30) Foreign Application Priority Data
Jun. 29, 2006 (KR) KR 2006-0060040

(51) Int. Cl. E06B 5/10; E04G 17/00; E06B 9/56

(52) U.S. Cl. 52/204.69; 52/204.62; 52/745.18; 52/745.21

(57) ABSTRACT

A blast-resistant window assembly (19), including a window opening (22), and a window (20) sized to fit within the window opening. The assembly further includes at least one anchor (28), which consists of a base plate (60) connected to the window opening. The anchors have a tongue (36), which is connected to the window and is fixed to the base plate at a shear region (61) that is configured so that under force of a blast against the window, the tongue shears away from the base plate, thereby absorbing energy of the blast.

### FIELD OF THE INVENTION

The present invention relates generally to reducing the effects of blast, and specifically to reducing the effects of blast on windows within a structure.

### BACKGROUND OF THE INVENTION

The wall of an enclosed structure provides a measure of protection to occupants of the structure if a blast occurs outside the structure. Openings in the wall reduce the protection provided, and if the opening comprises a glazed window, the blast typically shatters the glass.

The shattering of the glass may harm the occupants.

Methods for mitigating the effects of blast on windows are known in the art. Conventional hardened window systems rely on the capacity of the glazing, which is retained within robust frames. Not only must the relatively stiff framing withstand the large forces collected by the glazing, but the structure to which these windows are attached must be able to accept the reaction forces. While this approach may provide the desired level of protection to the occupants, it typically requires a substantial thickness of laminated glass and relatively heavy framing. Furthermore, the anchorage required to accommodate the substantial reaction forces presents major construction challenges.

A number of other systems are also known for mitigating blast effects. U.S. Patent Application 2002/0184839 to Emek, whose disclosure is incorporated herein by reference, describes a window protection system that may be applied to an already existing window of a building. The disclosure describes adding a second window, having blast mitigating features, to the existing window, so that even if the existing window shatters, the second window and the mitigating features provide protection to occupants of the building.

U.S. Pat. Nos. 6,718,705, 6,497,077, and 6,494,000 to Emek, whose disclosures are incorporated herein by reference, describe using cables stretched across an inner surface of a window as part of a system to absorb the effects of blast. The cables are coupled to energy absorbing structures which are activated by the blast.

### SUMMARY OF THE INVENTION

In embodiments of the present invention, a window anchor is formed with a tongue fixed to, and typically partially protruding from, a base plate. The tongue is connected to the base plate at one or more regions which are designed to shear in a particular direction, termed the axis of the anchor, so that the tongue may shear away from the base plate. The regions are hereinbelow termed shear-regions. A multiplicity of anchors are attached to an opening for a window, and the tongue of each anchor is attached to a frame of the window, thereby mounting and retaining the window and its frame in the opening. The axes of the anchors are aligned so that on receipt of a blast, the tongues shear from their base plates. During the shearing, the tongues remain attached to both the frame and their base plates, so that the window moves as a whole. The shearing of the shear-regions absorbs much of the blast energy, and this energy absorption, together with the ability of the window to move as a whole, substantially mitigates blast effects on the window.

In some embodiments, the shear-regions are divided into different sub-regions, each having a respective force level before activating, i.e., shearing, and a respective length. The sub-regions activate sequentially. In one embodiment there are three sub-regions, a first and a third sub-region having a high force of activation. In a second sub-region, intermediate the first and third sub-regions, the base plate is weakened so as to have a lower force of activation compared to the other sub-regions. The first sub-region has a short length, while the other regions are longer, although the lengths and forces of activation of the sub-regions may be adjusted to accord with window requirements. The high force of activation of the first sub-region means that the window is held in place firmly in the case of non-blast situations, such as high wind, while the short length of the sub-region ensures that once activated there is very little time before the second sub-region activates. Typically the anchor is manufactured by a stamping process in a press, so that parameters of the different sub-regions may be easily adjusted for different window requirements by altering the press.

In an alternative embodiment of the present invention, retaining straps couple the window frame to the opening. The retaining straps may be used in addition to the anchors or independently of these anchors, possibly in conjunction with other blast resistance mechanisms. The retaining straps are mounted in a compressed form, and extend on receipt of the blast. The straps act to retain the window approximately in place if the blast causes the tongues to completely separate from their base plates.

There is therefore provided, according to an embodiment of the present invention, a blast-resistant window assembly, including:

a window opening;

a window sized to fit within the window opening; and at least one anchor, which includes a base plate connected to the window opening and a tongue, which is connected to the window and is fixed to the base plate at a shear region that is configured so that under force of a blast against the window, the tongue shears away from the base plate, thereby absorbing energy of the blast.

Typically, at least a part of the tongue protrudes from the base plate, and the part is connected to the window.

Typically, the base plate lies in a plane, and at least a part of the tongue is coplanar with the plane.

In an embodiment the shear region includes a sub-region of the base plate that has been deformed so as to have a shearing force weaker than a non-deformed region of the base plate. The sub-region includes one or more grooves formed in the base plate, and a parameter of the grooves is set according to at least one of the weaker shearing force and an energy absorbed by the weaker shearing force. The sub-region includes one or more holes formed in the base plate, and a parameter of the holes is set according to at least one of the weaker shearing force and an energy absorbed by the weaker shearing force.

Typically, the shear region includes a further sub-region having a shearing force greater than the weaker shearing force; a dimension of the further sub-region is set according to at least one of the greater shearing force and an energy absorbed by the greater shearing force; and the further sub-region is connected to the sub-region and is located in a position chosen from a first position closer to the blast than the sub-region and a second position further from the blast than the sub-region.

In an alternative embodiment, the assembly includes at least one strap having a first end and a second end, which is connected to the window at the first end and to the opening at the second end and which is configured so that under force of a blast against the window, the strap extends allowing the window to move away from and remain in proximity to the opening.

There is further provided, according to an embodiment of the present invention, a blast-resistant window assembly, including:

a window opening;

a window sized to fit within the window opening; and

at least one retaining strap having a first end and a second end, which is connected to the window at the first end and to the opening at the second end and that is configured so that under force of a blast against the window, the strap extends allowing the window to move away from and remain in proximity to the opening.

Typically, the strap is implemented from one of a flexible material and a spring.

There is further provided, according to an embodiment of the present invention, apparatus for anchoring a window in an opening of a structure, including:

a plurality of anchors, each anchor having a tongue fixedly connected to a base plate, the tongue being adapted to connect fixedly to the window, the base plate being adapted to connect fixedly to the opening and having a region which is designed to shear the tongue away from the base plate under force of a blast against the window, thereby absorbing energy of the blast.

There is further provided, according to an embodiment of the present invention, a method for resisting blast, including:

providing a window opening;

fitting a window within the window opening; and

attaching at least one anchor between the window and the window opening, the at least one anchor including a base plate connected to the window opening and a tongue, which is connected to the window and is fixed to the base plate at a shear region that is configured so that, under force of the blast against the window, the tongue shears away from the base plate, thereby absorbing energy of the blast.

The present invention will be more fully understood from the following detailed description of the embodiments thereof, taken together with the drawings, a brief description of which follows.

### BRIEF DESCRIPTION OF THE DRAWINGS

FIG. 1 is a schematic isometric drawing of a window mounting assembly, according to an embodiment of the present invention;

FIGS. 2A and 2B are schematic cross-sections of FIG. 1;

FIG. 3 is a schematic diagram of an anchor used in the assembly of FIG. 1, according to an embodiment of the present invention;

FIG. 4 is a schematic cross-section of the anchor of FIG. 3;

FIG. 5 is a schematic diagram of the anchor used in the assembly of FIG. 1, according to an alternative embodiment of the present invention;

FIGS. 6 and 7 are schematic cross-sections of the anchor of FIG. 5;

FIG. 8 is a schematic isometric drawing illustrating the initial effects of a blast on the window mounting assembly of FIG. 1, according to an embodiment of the present invention;

FIGS. 9A and 9B are schematic cross-sections of FIG. 8;

FIG. 10 is a schematic isometric drawing illustrating later effects of the blast on the window mounting assembly of FIG. 1, according to an embodiment of the present invention;

FIGS. 11A and 11B are schematic cross-sections of FIG. 10;

FIG. 12 is a schematic isometric drawing illustrating an alternative window mounting assembly, according to an embodiment of the present invention; and

FIG. 13 is a schematic graph of force vs. length, according to an embodiment of the present invention.

### DETAILED DESCRIPTION OF EMBODIMENTS

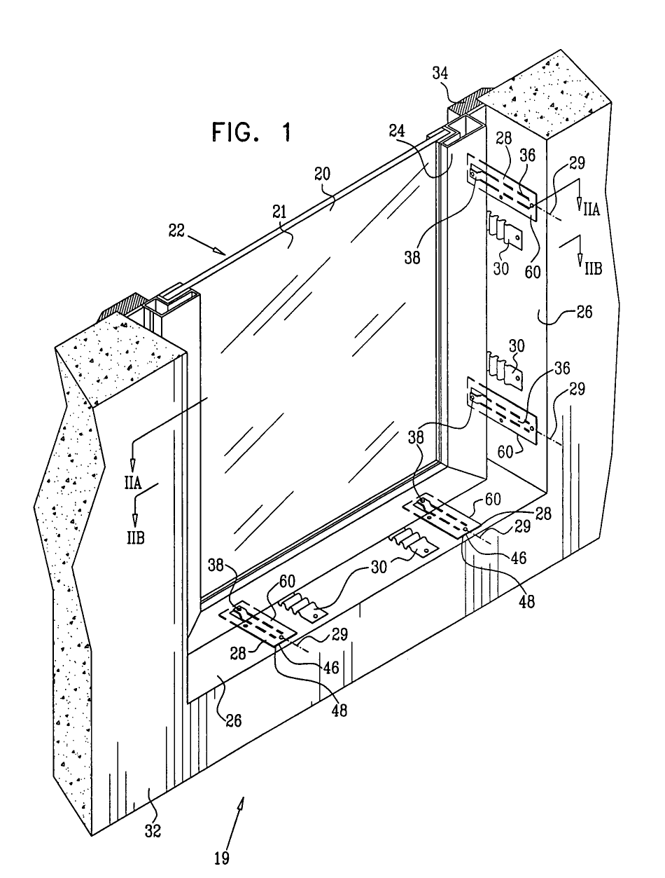

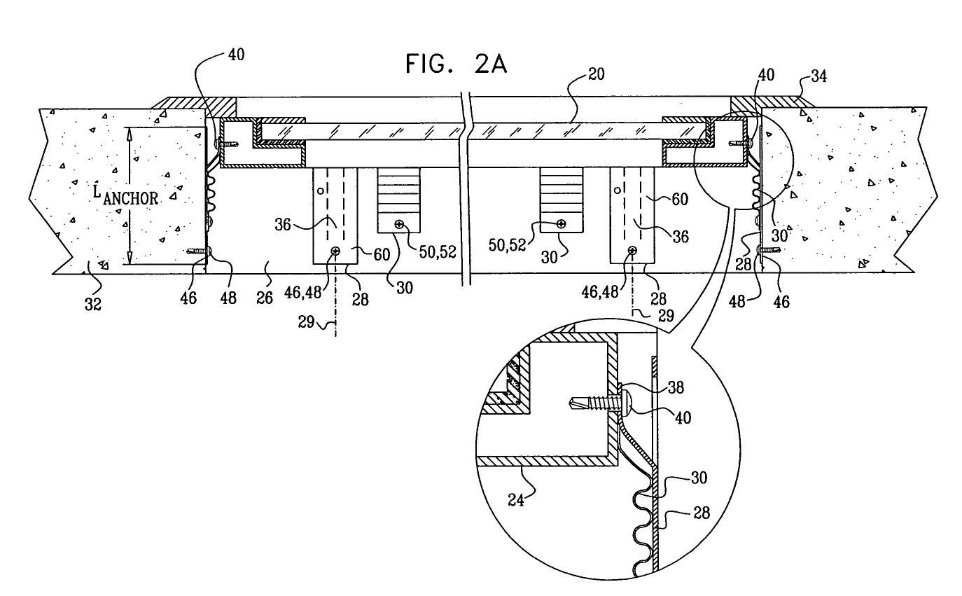

Reference is now made to FIG. 1, which is a schematic isometric drawing of a window mounting assembly 19, according to an embodiment of the present invention. Reference is also made to FIGS. 2A and 2B, which are cross-sections of FIG. 1. FIGS. 1, 2A, and 2B, show a window 20 mounted in an opening 22 of a structure 32. In the specification and in the claims, the term window is also assumed to comprise a door, curtain-wall, and/or other fenestration product which may be mounted in an opening of a structure. Window 20 comprises a retaining frame 24, typically formed from extruded aluminum, and for clarity a top portion of frame 24 is not shown in the figure. Window 20 has internal material 21, typically glazing, although it will be appreciated that the internal material may be formed from other materials suitable for mounting within frame 24, such as plastic or metal sheet. Internal material 21 is typically laminated, or has another form of protection known in the art, so that in the event of the window breaking the broken parts are retained within frame 24. A casing 34, connected to structure 32, seals the space between the window frame and the structure.

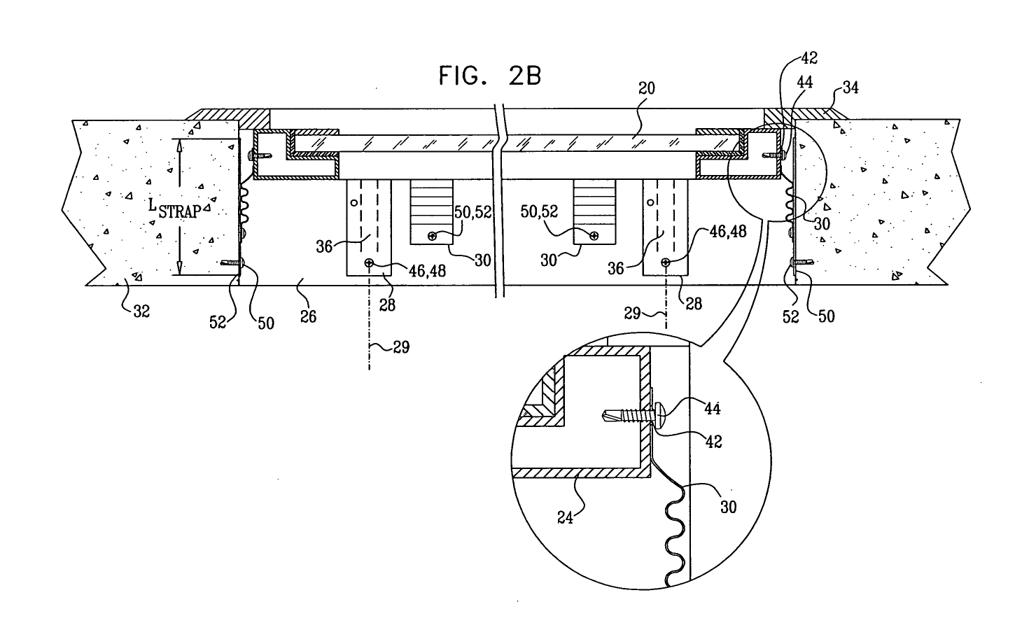

Frame 24 is connected to sides 26 of opening 22 by anchors 28, which are typically generally rectangular in form. By way of example, eight anchors 28 are assumed to connect window 20 to sides 26, of which four are shown in FIG. 1. It will be understood, however, that the number of anchors 28 used to connect frame 24 to sides 26 is a function of the size and shape of opening 22, and of a specified blast environment, and may be larger or smaller than eight. Each anchor 28 has a tongue 36 fixed to a base plate 60 of the anchor, the tongue typically although not necessarily protruding from the anchor, and having a connecting hole 38 formed in the tongue. A screw 40 (FIG. 2A) through the connecting hole fixes the tongue to frame 24. As explained in more detail below, tongue 36 shears along a particular direction 29, termed the axis of anchor 28, when a blast is received by window 20, so that the anchors are typically connected to sides 26 with their axes 29 approximately orthogonal to a plane of the window. However, as will be appreciated from the description below, at least some of anchors 28 may be installed non-orthogonally to the window plane and still act as energy absorbing devices. Typically, a thickness of sides 26 is greater than an overall length L_{anchor} of anchors 28, so that the anchors do not protrude from opening 22. Further details of the structure and function of anchors 28 are given below, with reference to FIGS. 3-7.

In some embodiments of the present invention, in addition to anchors 28, retaining straps 30 also couple the window to sides 26. The following description assumes that, by way of example, eight straps 30 are used to couple window 20 to sides 26. Typically, the number of straps used is a function of the size and shape of the opening 22, may be larger or smaller-than eight, and is not necessarily equal to the number of anchors. Straps 30 are typically made from flexible material that is compressible into a form such as the serpentine compression form illustrated in FIGS. 1, 2A, and 2B. Suitable flexible material for straps 30 includes, but is not limited to, metal, nylon, cord, and/or plastic, and the material may be partially or wholly woven. In one embodiment, straps 30 comprise springs. The function and method for mounting straps 30 is explained in more detail below.

Typically, each strap 30 also has a connecting hole 42 formed in the strap, and a screw 44 (FIG. 2B) through the connecting hole fixes the strap to frame 24. Alternatively or additionally, strap 30 may be connected to frame 24 and/or to opening 22 by means of a clip), or by any other convenient connecting means known in the art. Typically, to install window 20 in opening 22, the anchors and straps are first connected by their screws to frame 24. The window with its anchors and straps connected is then positioned in opening 22. Once in position, the anchors are screwed to sides 26, using screws 46 in holes 48 of each anchor; the straps are also screwed to sides 26, using screws 50 through holes 52 of each strap. As shown in FIG. 2B, straps 30 are typically installed in a compacted state, such as the serpentine shape illustrated in the figures, with a length Lₛₜᵣₐₚ.

In an alternative embodiment of the present invention, retaining straps 30 are used alone, i.e., without anchors 28, or the straps may be with blast resistance mechanisms other than anchors 28.

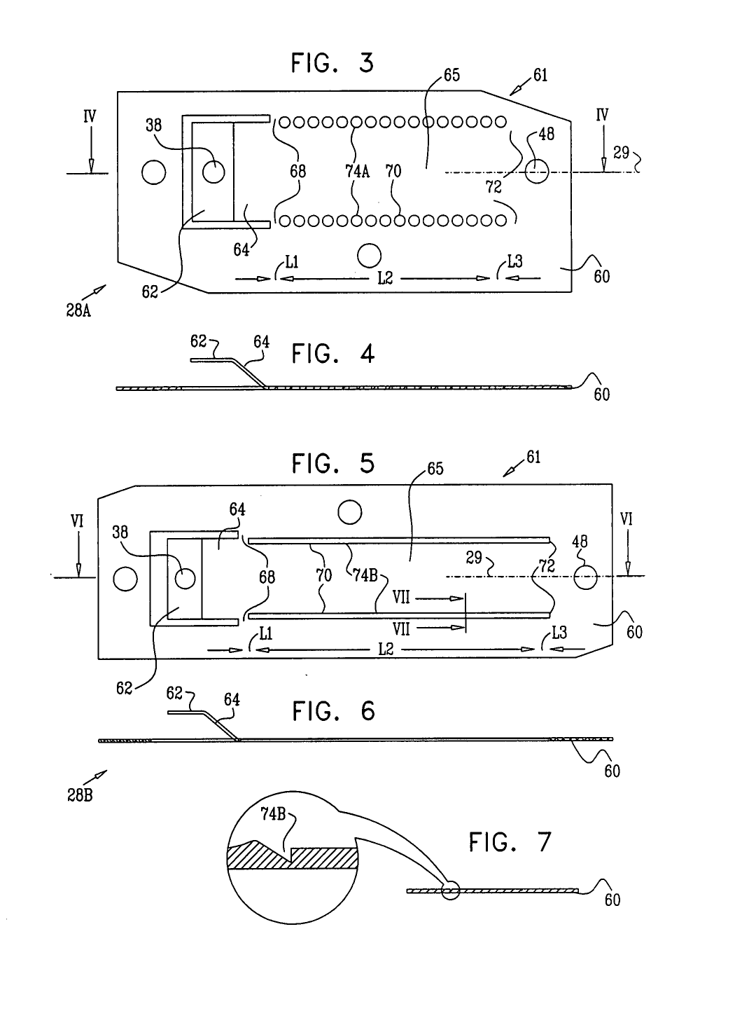

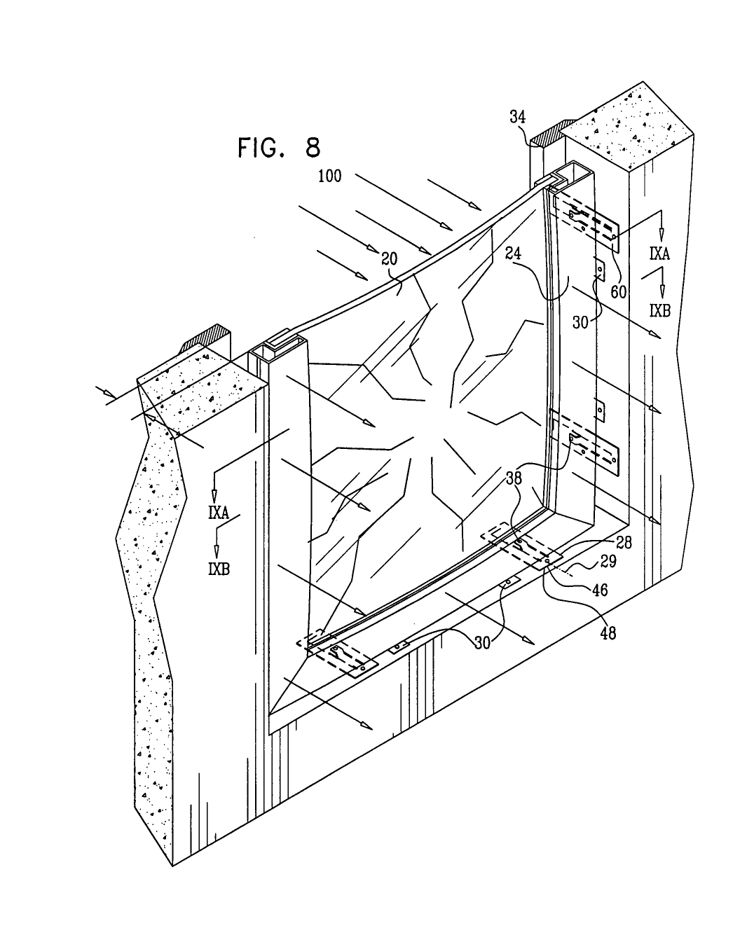

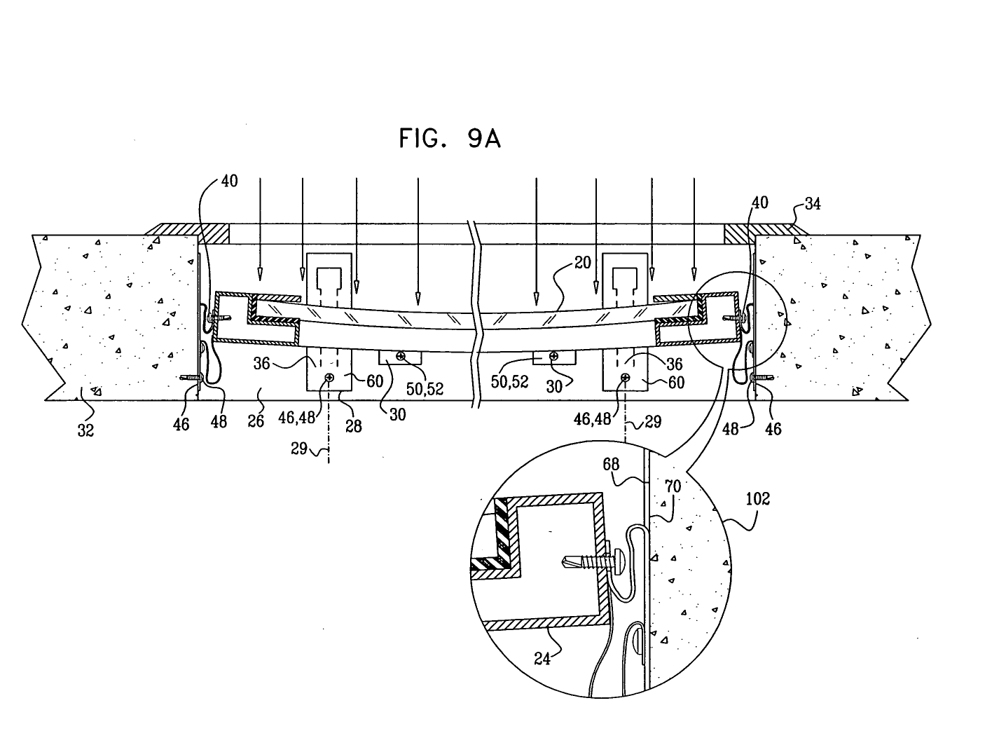

FIG. 3 is a schematic diagram of anchor 28, and FIG. 4 is a cross-section of the anchor, according to one embodiment of the present invention. FIG. 5 is a schematic diagram of anchor 28, and FIGS. 6 and 7 are cross-sections of the anchor, according to an alternative embodiment of the present invention. Hereinbelow, to differentiate the anchors of FIG. 3 and FIG. 5, identifying numerals of the former have a suffix A, and identifying numerals of the latter have a suffix B. In cases where elements of the anchors differ, the suffixes are also applied to the elements.

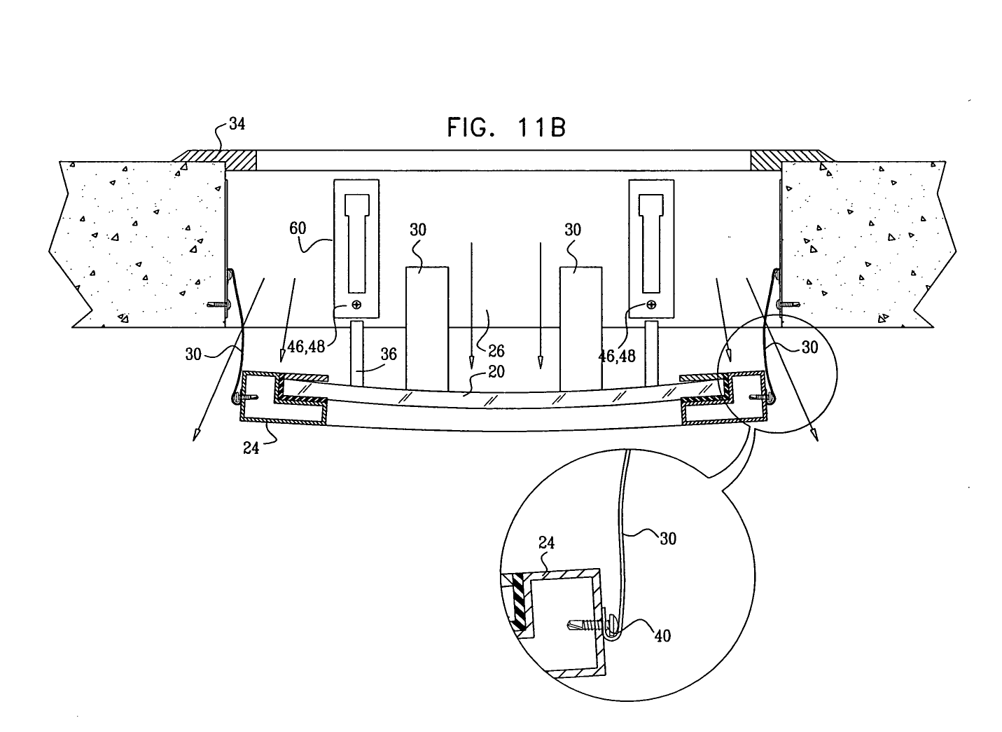

Anchor 28A and anchor 28B, also herein referred to generically as anchor 28, both comprise substantially similar tongues 36 which protrude from the anchor, leaving a hole 66 in the anchors. As described in more detail below, on receipt of a blast tongues 36 shear parallel to axis 29 and may eventually separate from anchors 28A and 28B, leaving a base plate 60. Base plate 60 is a generally planar portion of anchor 28, which has a generally closed “O” form, such as is also illustrated in FIG. 11A below. Typically, tongue 36 is formed to have a generally planar section 62 approximately parallel to base plate 60, and the planar-section is connected by an angular section 64 to a remaining part 65 of the tongue. Connecting holes 38 are formed in planar sections 62; connecting holes 48 are formed in base plates 60.

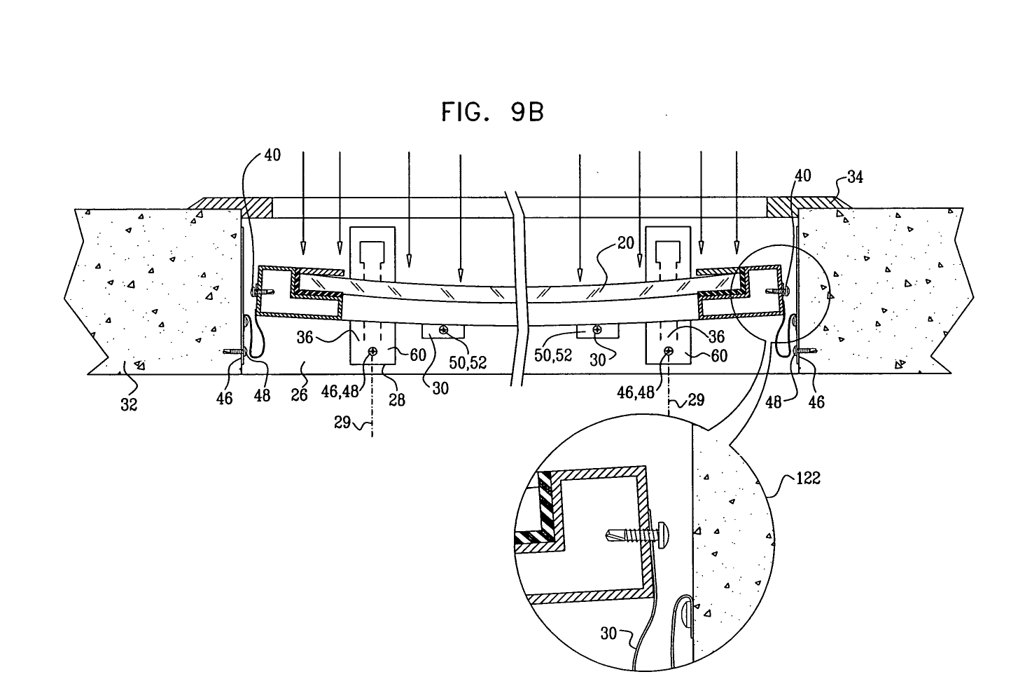

Each base plate 60 has a region 61 which is designed to shear on receipt of a blast. At least part of region 61 has been deformed so as to be weakened to shear, compared to non-deformed regions of base plate 60. Region 61 is typically divided into sub-regions, each of which has a respective length and a force of activation, i.e., a force required for shearing to occur. By way of example, anchors 28 are assumed to have three such sub-regions. In both anchors a second central weakened sub-region 70 separates a first sub-region 68 from a third sub-region 72. The central weakened sub-regions are formed differently in anchors 28A and 28B. Sub-region 70 in anchor 28A is formed as a pair of sets of holes 74A; sub-region 70 in anchor 28B is formed as a pair of grooves 74B, shown as a cross-section detail in FIG. 7. In both anchors the central weakened sub-region is assumed to have a length L₂, the first sub-region a length L₁, and the third sub-region a length L₃. Typical values of L₂, L₁, and L₃ are approximately of the order of 100 mm, 1 mm, and 1-20 mm respectively, although as will be apparent from the following description, the actual values are functions of the material and thickness of the anchors, as well as the desired forces and energies of shearing. As explained below, L₃ may vary, depending on how tongue 36 separates from its base plate. The shearing effect of the different sub-regions is described below with reference to FIGS. 8, 9A, 9B, 10, 11A, and 11B.

It will be appreciated that the complete anchor 28, including the weakened sub-regions of the base plate and tongue 36, may be advantageously formed by stamping from sheet metal in a press. It will also be appreciated that other forms of anchor 28, different from the particular anchors 28A and 28B described above, but having one or more substantially similar regions weakened to shear, will be apparent to those having ordinary skill il the art. For example, rather than holes or grooves delineating central weakened sub-region 70, sub-region 70 may be formed by a series of parallel equal-length grooves or indentations formed at right angles to axis 29 of the anchor. All such forms are assumed to be included within the scope of the present invention.

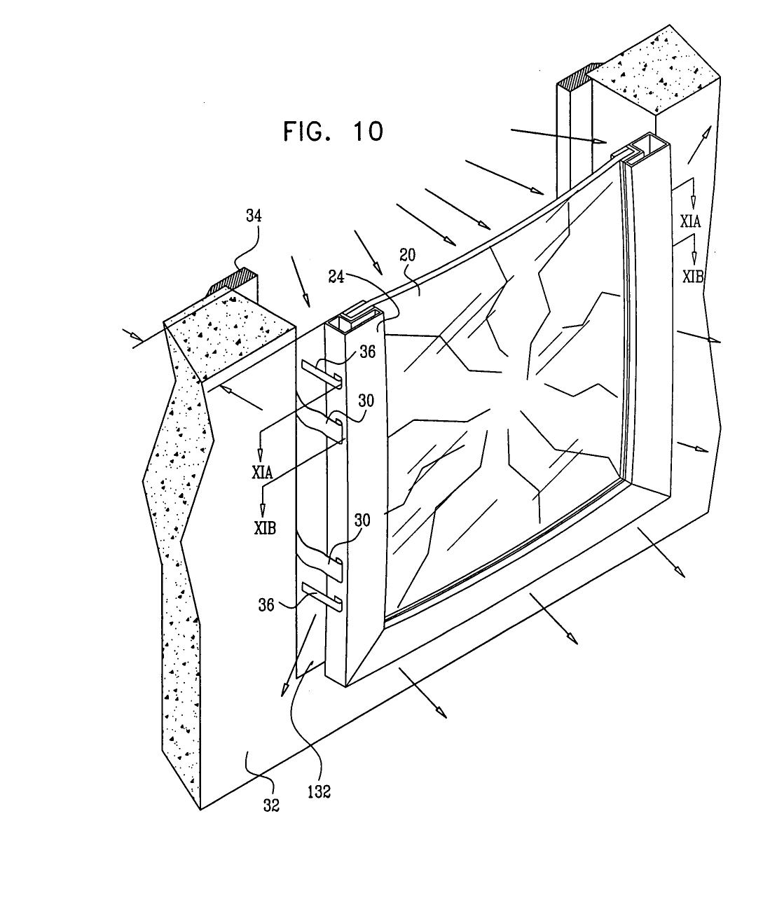

FIG. 8 is a schematic isometric drawing illustrating the initial effects of a blast 100 on window 20, and FIGS. 9A and 9B are schematic cross-sections of FIG. 8, according to all embodiment of the present invention. As shown in FIGS. 8, 9A, and 9B, on initial receipt of blast 100, window 20 bows inwards and may begin to break. The force of the blast also causes frame 24 to move away from casing 34. Since frame 24 is connected to tongues 36, the frame exerts an initial force on the tongues. As shown in FIG. 9A and in inset 102, the initial force causes tongues 36 to bend backwards, and to shear at sub-region 68 and an initial part of sub-region 70 in the direction of axes 29 of the anchors. As shown in inset 122 (FIG. 9B), the movement of frame 24 causes straps 30 to open from their compressed state shown in FIG. 2B.

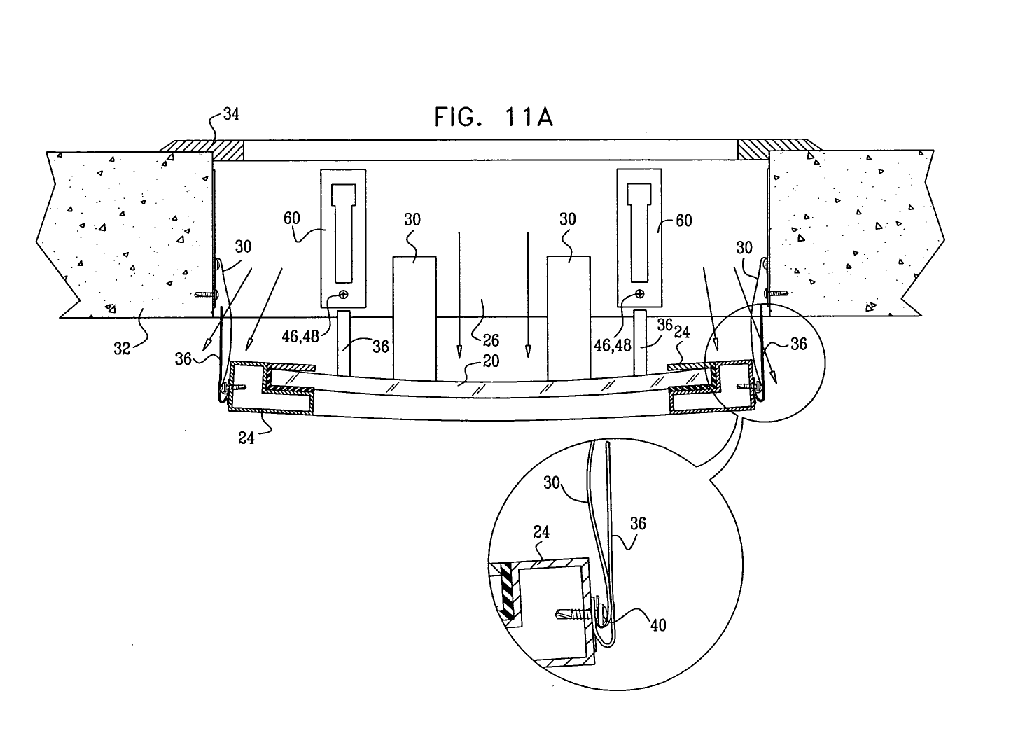

The force of the blast causes frame 24 to continue moving away from casing 34, and thus tongues 36 continue to shear sub-regions 70. The shearing of each sub-region 70 typically continues until all the sub-region has completely sheared. At this point, the continuing movement of the frame may cause shearing in sub-region 72 to begin. Shearing il sub-region 72 causes each tongue to separate from base plate 60 of its anchor 28, causing the situation illustrated in FIGS. 10, 11A, and 11B.

FIG. 10 is a schematic isometric drawing illustrating later effects of blast 100, and FIGS. 11A and 11B are schematic cross-sections of FIG. 10, according to an embodiment of the present invention. As shown in the figures, tongues 36 have completely separated from their base plates 60, the latter remaining attached to sides 26. In addition, frame 24 has moved outside opening 22, leaving a gap 132 between sides 26 and the frame. Frame 24 is held in place by straps 30, which are typically caused to extend to their fullest extent by the force of the blast. Straps 30 thus hold window 20 in place, as shown.

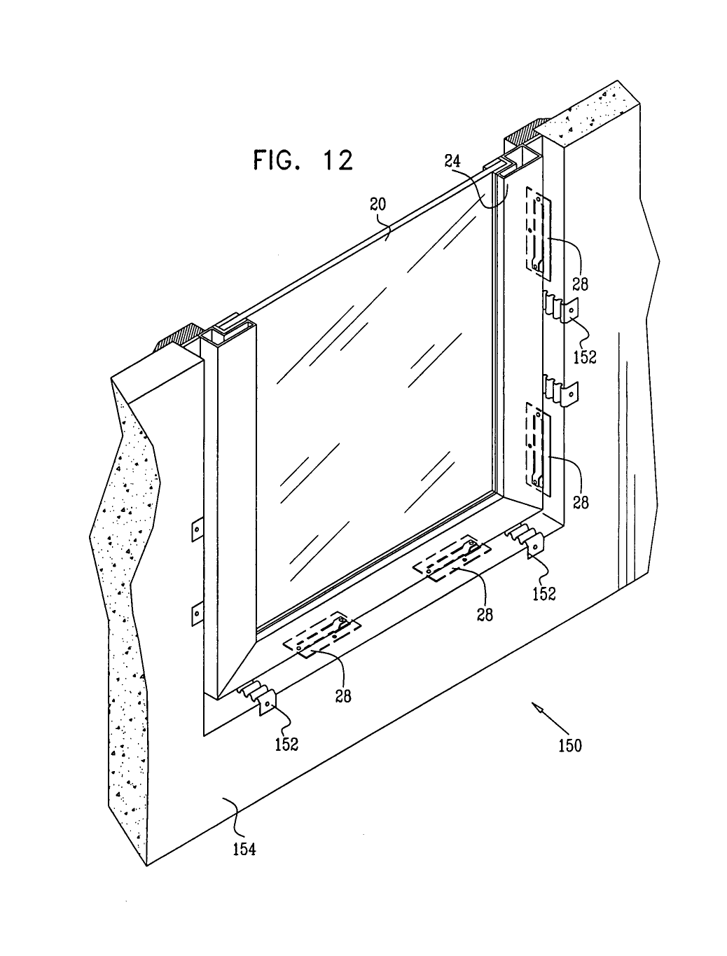

FIG. 12 is a schematic isometric drawing illustrating an alternative window mounting assembly 150 using anchors 28 and straps 30, according to an embodiment of the present invention. Apart from the differences described below, assembly 150 is generally similar to that of assembly 19, such that elements indicated by the same reference numerals in both assembly 19 and assembly 150 are generally identical in construction and in operation. Assembly 150 may be advantageously implemented when sides 26 are relatively narrow, so that an overall length L_{anchor} of anchors 28, and/or an overall compressed length Lₛₜᵣₐₚ of straps 30, is greater than the thickness of sides 26. In assembly 150, anchors 28 are mounted with their axes 29 approximately parallel to the plane of window 20, rather than approximately orthogonal to the window as in assembly 19. Also, straps 30 may be mounted so that a portion 152 of the straps is connected to an inside wall 154 of structure 32. Thus, both anchors 28 and/or straps 30 may be used to secure window 20 to sides 26 when the latter are relatively narrow.

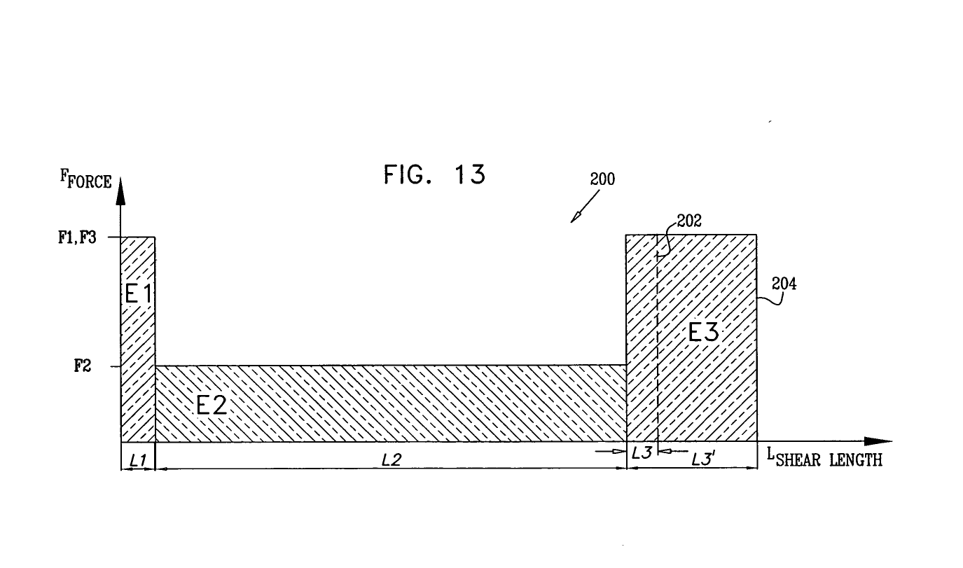

FIG. 13 is a schematic graph 200 of force vs. length, according to an embodiment of the present invention. The vertical axis of the graph plots values of shearing force applied to tongue 36 as it shears from its initial position illustrated in FIG. 1. The horizontal axis of the graph plots lengths measured along axis 29 of anchors 28, using the lengths L₁, L₂, and L₃ of sub-regions 68, 70, and 72 respectively.

The force required to shear a material is given by:
F=S×Lₑ×T (1)
where F (N) is the force on the material,
S (Nm⁻²) is the ultimate shear strength of the material,

Lₑ (m) is an effective length of the material in a direction at right angles to force F, and

T (m) is an effective thickness of the material.

For a given shearing length L of material, corresponding to L₁, L₂, or L₃, i.e., in a direction parallel to force F, the energy absorbed by the shearing force is given by:
E=F×L (2)
where E (J) is the energy absorbed.

Combining equations (1) and (2) gives:
E=S×Lₑ×T×L (3)

Embodiments of the present invention set the values of Lₑ, L, and T for each sub-region, in order to vary the sub-region's shearing force and energy absorbed. It will be understood that for anchors 28, since shearing occurs parallel to axis 29 of the anchors, Lₑ is a length of sheared material at right angles to the axis.

In first sub-region 68, L₁ is short, Lₑ is of the same order, and thickness T is the thickness of anchor 28, herein termed T₁, and typically also of the same order as L₁. From equations (1) and (3) the shearing force F1 and the energy absorbed E1 for sub-region 68 are given by:
F1≈S×L₁×T1
E1≈S×L₁²×T₁ (4)

Equations (4) apply to both anchors 28A and 28B.

In second sub-region 70 the value of the shearing force is approximately constant for anchor 28B, and depends on the depth and angle of grooves 74B, since these effectively set the values of Lₑ and T. The thickness T, herein termed T₂, is assumed to be the material thickness at the bottom of grooves 74B; the effective length Lₑ is typically nT₂, where n is a factor typically in a range from approximately 1 to approximately 10. Herein, by way of example, n is assumed to be 2. The shearing force F2 and the energy absorbed E2 for sub-region 70 of anchor 28B are then given by:
F2≈×2T₂²
E2≈×2T₂²×L₂ (5)

In second sub-region 70, for anchor 28A the value of the shearing force averaged along the sub-region depends on the size and spacing of holes 74A. The larger and closer the holes, the smaller the average shearing force; conversely, the smaller and more distant the holes, the larger the average shearing force. Thus, those with ordinary skill in the art will be able to adapt equations (5), mutatis mutandis, to derive generally similar equations using an average force value for the second sub-region of anchor 28B.

In third sub-region 72, complete separation of tongue 36 from base plate 60 occurs, by further shearing of anchor 28. The further shearing typically leaves base plate 60 connected to sides 26; alternatively, the further shearing may cause at least part of base plate 60 to also shear into parts, one part remaining with tongue 36. In either case, equations for the third sub-region will be of the general form:
F3≈S×2T₁
E3≈S×2₁²×L₃ or
E3≈S×2T₁²×L₃ (6)

where T₁ is the full thickness of anchor 28, L₃ is the length of sub-region 72 for the case where no part of base plate 60 shears, and L₃′ is the length of the sheared material if part of base plate 60 also shears.

Graph 200 illustrates the values of forces and absorbed energies given by equations (4), (5), and (6), the energies corresponding to the labeled areas of the graph. A line 202 corresponds to tongue 36 separating from its anchor to leave base plate 60; a line 204 corresponds to the tongue and part of the base plate separating from a remaining part of the base plate. The total absorbed energy, E1+E2+E3, corresponds to the total area under the graph.

Typically, as illustrated by graph 200, second section 70 of anchor 28 is implemented to have a relatively low shearing force and a relatively long length. With this combination shearing of the second section provides a large energy absorbing capacity while exerting a relatively low force on the sides of the window opening.

From inspection of equations (4), (5), and (6), and of graph 200, it will be understood that the values of F1, E1, F2, E2, F3, E3, and total absorbed energy may be adjusted by varying parameters of anchor 28, e.g., lengths L₁, L₂, and/or L₃ and/or, in the case of the weakened region of anchor 28B the depth and orientation of the grooves, and/or, in the case of the weakened region of anchor 28A the size and spacing of holes. It will also be understood that the force values are substantially independent of each other, so that, for example, F3 may be set to be larger than F1 and F2. Although such adjustments are typically made to accord with specific requirements of the window, it will be appreciated that their values are substantially independent of the type of window, the method of installing the window, and the nature of the window response to the blast. It will also be understood that in some embodiments of the present invention, lengths L₁ and/or L₃ may be short, i.e., effectively zero, so that substantially all the energy of absorption occurs as E₂.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

We claim:

1. A blast-resistant window assembly, comprising:
a window opening;
a window sized to fit within the window opening; and
at least one anchor, which comprises a base plate connected to the window opening and a tongue, which is connected to the window and is fixed to the base plate at a shear-region that is configured so that under force of a blast against the window, the tongue shears away from the base plate, thereby absorbing energy of the blast.

2. The assembly according to claim 1, wherein at least a part of the tongue protrudes from the base plate, and wherein the part is connected to the window.

3. The assembly according to claim 1, wherein the base plate lies in a plane, and wherein at least a part of the tongue is coplanar with the plane.

4. The assembly according to claim 1, wherein the shear region comprises a sub-region of the base plate that has been deformed so as to have a shearing force weaker than a non-deformed region of the base plate.

5. The assembly according to claim 4, wherein the sub-region comprises one or more grooves formed in the base plate, and wherein a parameter of the grooves is set according to at least one of the weaker shearing force and an energy absorbed by the weaker shearing force.

6. The assembly according to claim 4, wherein the sub-region comprises one or more holes formed in the base plate, and wherein a parameter of the holes is set according to at least one of the weaker shearing force and an energy absorbed by the weaker shearing force.

7. The assembly according to claim 4, wherein the shear region comprises a further sub-region having a shearing force greater than the weaker shearing force.

8. The assembly according to claim 7, wherein a dimension of the further sub-region is set according to at least one of the greater shearing force and an energy absorbed by the greater shearing force.

9. The assembly according to claim 7, wherein the further sub-region is connected to the sub-region and is located in a position chosen from a first position closer to the blast than the sub-region and a second position further from the blast than the sub-region.

10. The assembly according to claim 1, and comprising at least one strap having a first end and a second end, which is connected to the window at the first end and to the opening at the second end and which is configured so that under force of a blast against the window, the strap extends allowing the window to move away from and remain in proximity to the opening.

11. A blast-resistant window assembly, comprising:
a window opening;
a window sized to fit within the window opening; and
at least one retaining strap having a first end and a second end, which is connected to the window at the first end and to the opening at the second end and that is configured so that under force of a blast against the window, the strap extends allowing the window to move away from and remain in proximity to the opening.

12. The assembly according to claim 11, wherein the strap is implemented from one of a flexible material and a spring.

13. Apparatus for anchoring a window in an opening of a structure, comprising:
a plurality of anchors each anchor having a tongue fixedly connected to a base plate, the tongue being adapted to connect fixedly to the window, the base plate being adapted to connect fixedly to the opening and having a region which is designed to shear the tongue away from the base plate under force of a blast against the window, thereby absorbing energy of the blast.

14. A method for resisting blast, comprising:
providing a window opening;
fitting a window within the window opening; and
attaching at least one anchor between the window and the window opening, the at least one anchor comprising a base plate connected to the window opening and a tongue, which is connected to the window and is fixed to the base plate at a shear region that is configured so that, under force of the blast against the window, the tongue shears away from the base plate, thereby absorbing energy of the blast.

15. The method according to claim 14, wherein at least a part of the tongue protrudes from the base plate, and comprising connecting the part with the window.

16. The method according to claim 14, and comprising forming the base plate as a plane, and forming at least part of the tongue to be coplanar with the plane.

17. The method according to claim 14, and comprising deforming a sub-region of the shear region to have a shearing force weaker than a non-deformed region of the base plate.

18. The method according to claim 17, wherein the sub-region comprises one or more grooves formed in the base plate, and wherein a parameter of the grooves is set according to at least one of the weaker shearing force and an energy absorbed by the weaker shearing force.

19. The method according to claim 17, wherein the sub-region comprises one or more holes formed in the base plate, and wherein a parameter of the holes is set according to at least one of the weaker shearing force and an energy absorbed by the weaker shearing force.

20. The method according to claim 17, wherein the shear region comprises a further sub-region having a shearing force greater than the weaker shearing force.

21. The method according to claim 20, and comprising setting a dimension of the further sub-region according to at least one of the greater shearing force and an energy absorbed by the greater shearing force.

22. The method according to claim 20, and comprising connecting the further sub-region to the sub-region and locating the further sub-region in a position chosen from a first position closer to the blast than the sub-region and a second position further from the blast than the sub-region.

23. The method according to claim 14, and comprising:
providing at least one strap having a first end and a second end;
connecting the first end of the at least one strap to the window; and
connecting the second end of the at least one strap to the opening, so that under force of a blast against the window, the at least one strap extends allowing the window to move away from and remain in proximity to the opening.
